(19) United States
(12) Patent Application Publication
(10) Pub. No.: US 2022/0078557 A1
(43) Pub. Date: Mar. 10, 2022

(54) SPEAKER

(71) Applicant: HOSIDEN CORPORATION, Osaka (JP)

(72) Inventors: Shunsuke KUROIWA, Osaka (JP); Masahito FUKADA, Osaka (JP); Atsushi NARA, Osaka (JP); Yoshito FUJIMOTO, Osaka (JP)

(21) Appl. No.: 17/381,431

(22) Filed: Jul. 21, 2021

(30) Foreign Application Priority Data
Sep. 4, 2020 (JP) 2020-149104

(51) Int. Cl. H04R 7/26; H04R 7/18; H04R 9/02; H04R 9/06; H04R 7/12

(52) U.S. Cl. CPC H04R 7/26; H04R 7/18; H04R 2400/11; H04R 9/06; H04R 7/12; H04R 9/025

(57) ABSTRACT

Provided is a speaker that allows compactization while achieving improvement in assembly readiness. The speaker includes a diaphragm having a vibration face portion vibrated to radiate a sound wave, a voice coil fixed to a back face of the vibration face portion, a frame supporting the diaphragm, a magnetic circuit vibrating the diaphragm and a mass adjustment member opposed to a surface of the diaphragm and configured to adjust the mass of the vibration face portion. The mass adjustment member includes a plate face portion fixed to the surface of the vibration face portion and a damper extending outwards from the plate face portion.

### CROSS REFERENCE TO RELATED APPLICATION

This application is based on and claims priority under 35 U.S.C. Section 119 to Japanese Patent Application No 2020-149104 filed on Sep. 4, 2020, the entire contents of which are incorporated herein by reference.

### TECHNICAL FIELD

This disclosure relates to a speaker having a damper.

### BACKGROUND ART

Conventionally, there is known a dynamic type speaker configured such that a voice coil is set in a magnetic field generated by a magnetic circuit and in association with feeding of a voice current to this voice coil, the voice coil per se is vibrated, which in turn vibrates a diaphragm placed in contact with the voice coil to radiate a sound wave (for instance, see Japanese Unexamined Patent Application No. 2013-30872 and Japanese Unexamined Patent Application No. 2009-290815). The speakers disclosed in Japanese Unexamined Patent Application No. 2013-30872 and Japanese Unexamined Patent Application No. 2009-290815 include a frame provided on the back face side of the diaphragm and include also a damper for damping abnormal vibration of the diaphragm.

The speaker disclosed in Japanese Unexamined Patent Application No. 2013-30872 includes a dome-shaped diaphragm, an edge having a front face formed convex and having one end connected to an outer circumferential edge of the diaphragm and a frame which fixes the other end of the edge. To the back face of this diaphragm, a bobbin is connected as a mass adding member and the voice coil is wound around this bobbin. Further, the speaker disclosed in Japanese Unexamined Patent Application No. 2013-30872 includes a damper which extends on the radially outer side of the bobbin, with one end of the damper being fixedly bonded to the outer circumferential face of the bobbin between the voice coil and the diaphragm and the other end of the damper being fixedly bonded to a bottom plate of the frame.

In the speaker disclosed in Japanese Unexamined Patent Application No. 2009-290815, the dome-shaped diaphragm has a dome portion at the center thereof and includes an edge portion formed convex on the surface side in a circumference of the dome portion. A bobbin suspends from the outer circumferential edge portion of the dome portion and the voice coil is wound around this bobbin. A damper formed integrally with the dome portion extends on the radially outer side of the bobbin and the leading end portion of the damper is fixedly bonded to the bottom plate of the frame.

### SUMMARY

In recent years, there is a growing popularity of a micro speaker for use in e.g. a mobile phone, accompanied by a need for thinning the speaker. In the case of the speakers disclosed in Japanese Unexamined Patent Applications No. 2013-30872 and No. 2009-290815, there is provided a bobbin connected to the diaphragm and a voice coil is wound around this bobbin. Thus, assembly was difficult in a small speaker such as a micro speaker. More particularly, in a small speaker such as a micro speaker, a space for providing a bobbin is often non-existent due to its arrangement. Further, as the bobbin is formed thin by forming it at a part of the diaphragm, the assembly was difficult. Moreover, in the case of the speakers disclosed in Japanese Unexamined Patent Applications No. 2013-30872 and No. 2009-290815, since a damper is provided on the back face side of the diaphragm, it is necessary to dispose the damper in such a manner as to circumvent the voice coil and the magnetic circuit. Hence, the degree of designing freedom would suffer, thus presenting a problem in contemplating thinning of the speaker.

In view of the above, there is a need for a speaker that allows compactization while achieving improvement in assembly readiness.

In view of the above, according to one aspect of this disclosure, there is provided a speaker comprising:

a diaphragm having a vibration face portion vibrated to radiate a sound wave;

a voice coil fixed to a back face of the vibration face portion;

a frame supporting the diaphragm;

a magnetic circuit vibrating the diaphragm; and

a mass adjustment member opposed to a surface of the diaphragm and configured to adjust the mass of the vibration face portion, the mass adjustment member including a plate face portion fixed to the surface of the vibration face portion and a damper extending outwards from the plate face portion.

In the above-described arrangement, since the voice coil is fixed to the back face of the diaphragm, there is no need to provide a bobbin, so that the assembly readiness can be improved. Further, since the mass adjustment member opposed to the surface of the diaphragm includes a damper, abnormal vibration of the diaphragm can be suppressed without increasing the number of components.

Further, since the damper is provided in the mass adjustment member which is opposed to the surface of the diaphragm, there is secured a space for accommodating such components as the voice coil and the magnetic circuit which are to be provided on the back face side of the diaphragm. As a result, the degree of designing freedom is increased and also compactization is made possible. Moreover, thanks to the damper extending outwards from the plate face portion fixed to the surface of the vibration face portion, it is possible to enhance vibration damping performance for abnormal vibration propagated from the vibration face portion via the plate face portion.

In this way, it has become possible to provide a speaker that allows compactization while achieving improvement in assembly readiness.

Preferably, the mass adjustment member has a greater rigidness than the diaphragm.

With the above-described arrangement of the mass adjustment member having a greater rigidness than the diaphragm, it becomes easier to output a bass (low-frequency) sound through reduction of the minimum resonance frequency, whereby the acoustic range of the speaker can be extended.

Preferably, the diaphragm includes an edge portion that extends in a circumference of the vibration face portion, the edge portion being formed convex on the back face side.

With the above-described arrangement of the edge portion being formed convex on the back face side, this leads to increase in the tensile stress on the back face side for the diaphragm, so that distortion of the diaphragm can be further suppressed. Moreover, it becomes possible to arrange the diaphragm and the mass adjustment member without having to care about possible interference between the damper of the mass adjustment member and the edge portion which are to be disposed on the surface of the diaphragm, whereby further compactization is made possible.

Further, preferably, the plate face portion has a rectangular shape and the damper includes a plurality of elongate plate portions each having one end connected to a pair of sides of the plate face portion and extending in a form of elongate plate from the sides and an annular portion connecting the other ends of the elongate plate portions.

With the above-described arrangement of the elongate plate portions of the damper being caused to extend from a pair of sides of the plate face portion, machining becomes easier and the vibration damping effect provided by the damper can be exerted in an effective manner. Further, with provision of the annular member connecting the other ends of the elongate plate portions, handling of the mass adjustment member is made easier, so that the assembly readiness can be even more improved.

Further, preferably, the diaphragm includes an annular circumferential edge portion which is to be bound by the frame and the annular portion is sandwiched between the circumferential edge portion and the frame, with the annular portion being overlapped with the circumferential edge portion.

With the above-described arrangement of the circumferential edge portion of the diaphragm and the annular portion of the mass adjustment member being overlapped with each other and being sandwiched, under this overlapped state, between the circumferential edge portion and the frame, this can not only enhance the assembly readiness, but also can stabilize the posture of the mass adjustment member.

Further, preferably, the plate face portion has a surface area greater than the vibration face portion.

With the above-described arrangement of making the surface area of the plate face portion greater than the surface area of the diaphragm portion, this increases the effective area of the plate face portion which is vibrated with the vibration face portion. Consequently, it becomes possible to increase the sound pressure, thus providing favorable sound quality.

### BRIEF DESCRIPTION OF THE DRAWINGS

FIG. 1 is an outer appearance perspective view of a speaker,

FIG. 2 is an exploded perspective view showing the speaker as seen from the upper side thereof,

FIG. 3 is an exploded perspective view showing the speaker as seen from the lower side thereof,

FIG. 4 shows IV-IV section in FIG. 1,

FIG. 5 shows a mass adjustment member relating to Further Embodiment (1),

FIG. 6 shows a mass adjustment member relating to Further Embodiment (2), and

FIG. 7 shows a mass adjustment member relating to Further Embodiment (3).

### DESCRIPTION OF EMBODIMENTS

Next, embodiments of a speaker relating to the present invention will be explained with reference to the accompanying drawings. In this embodiment, a dome-shaped dynamic type speaker will be explained as an example of a speaker X. However, the present invention is not limited to the embodiments disclosed, but various modifications are possible within a range not deviating from the essence thereof.

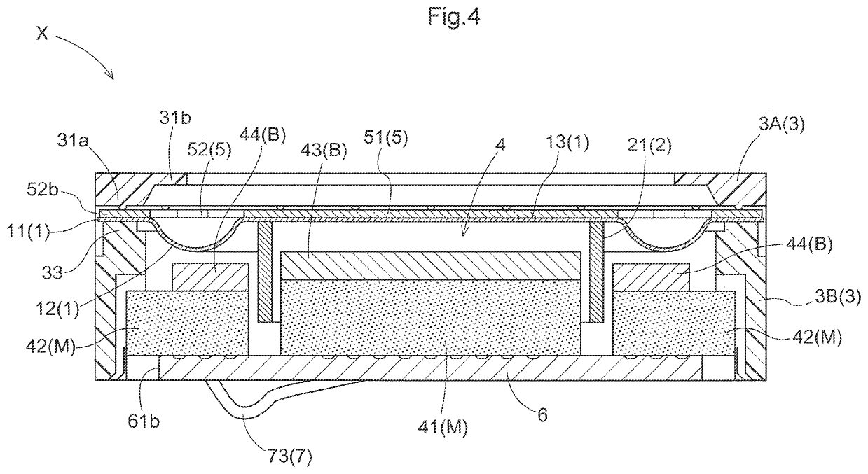

As shown in FIG. 4, the speaker X relating to this embodiment is configured as a dynamic type speaker in which a voice coil 2 is disposed within a magnetic field generated by a magnetic circuit 4 and with feeding of voice current to this voice coil 2, the voice coil 2 per se is vibrated and a diaphragm 1 to which the voice coil 2 is fixed is also vibrated to output a sound wave. In the following discussion, the side of the diaphragm 1 as seen from the voice coil 2 will be defined as the “upper” side, the opposite side will be defined as the “lower” side. Further, the stacking direction of the voice coil 2 and the diaphragm 1 will be defined as the vertical (upper/lower) direction and of the opposed sides of the diaphragm 1, the side thereof on the side of the voice coil 2 will be defined as the “back face” and the opposite side will be defined as the “surface (front face)”, respectively

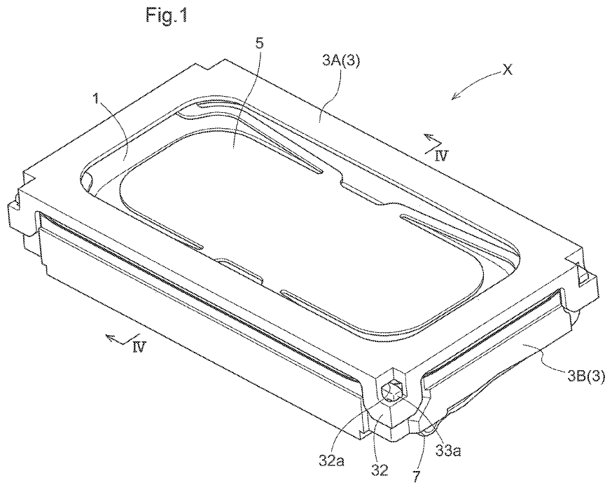

As shown in FIGS. 1 through 3, the speaker X includes the diaphragm 1 which is vibrated to radiate a sound wave, the voice coil 2 fixed to the back face of the diaphragm 1, a frame 3 supporting the diaphragm 1, a magnetic circuit 4 disposed inside the frame 3 and configured to vibrate the voice coil 2 through interlinkage of magnetic fluxes generated, a mass adjustment member 5 opposed to the surface of the diaphragm 1 and a bottom plate 6 to which the magnetic circuit 4 is fixed.

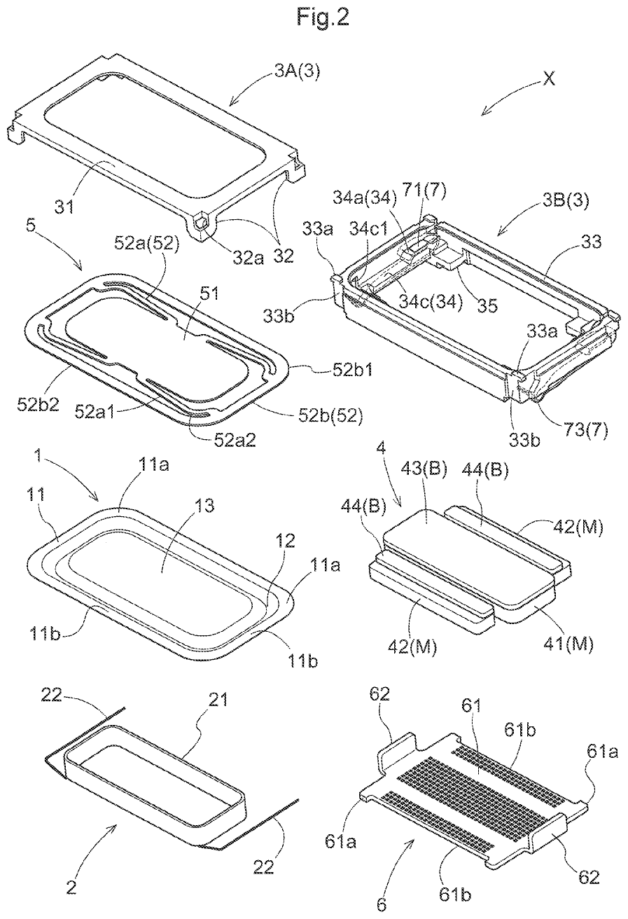

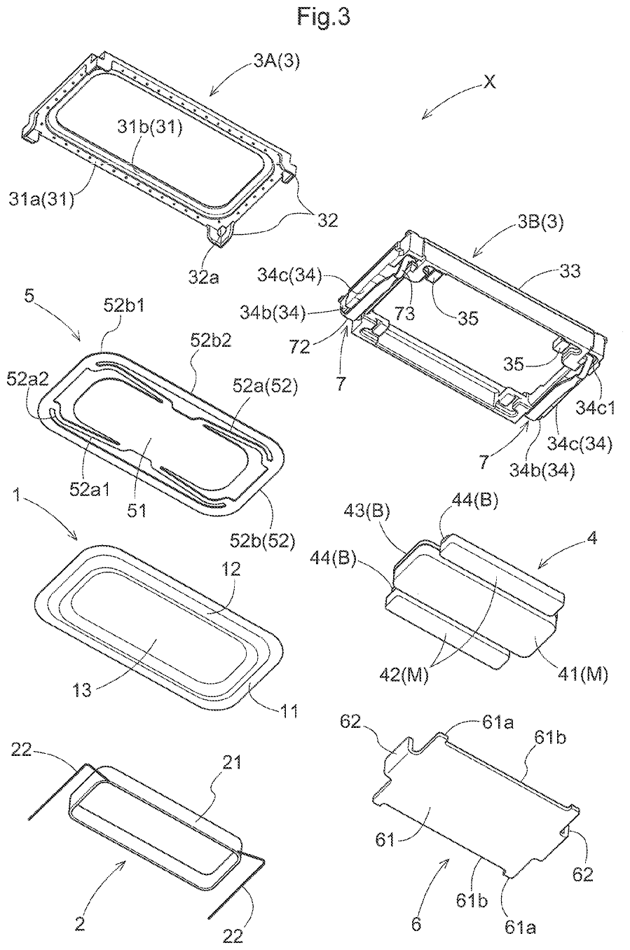

The diaphragm 1 is a member in the form of a thin plate configured to radiate a sound wave by propagation of vibration generated in the speaker X to the air. The diaphragm 1 is formed of a flexible material such as a resin film using e.g. PEEK (polyether ether ketone), a metal film, or the like. As shown in FIGS. 2 and 3, the diaphragm 1 includes an outer circumferential frame portion 11 (an example of a “circumferential edge portion”) having a rectangular annular shape, a rectangular annular edge portion 12 disposed on the inner circumferential side of the outer circumferential frame portion 11 and formed of a curved face convex downwards on the back face side of the diaphragm 1 and a vibration face portion 13 having a rectangular-shaped vibrating face disposed on the inner circumferential side of the edge portion 12.

The diaphragm 1 is fixed on a second frame portion 33 of a second frame 3B of the frame 3 to be described later, with the outer circumferential frame portion 11 of the diaphragm 1 being sandwiched between a first frame 3A and the second frame 3B of the frame 3. The back face of the outer circumferential frame portion 11 and the upper face of the second frame portion 33 of the second frame 3B are bonded to each other with an adhesive, for instance.

The outer circumferential frame portion 11 of the diaphragm 1 is formed of four arcuate corner portions 11a and four straight portions 11b formed between the respective adjacent corner portions 11a. The edge portion 12 is an annular movable member connecting the outer circumferential frame portion 11 with the vibration face portion 13. This edge portion 12 extends along the circumference of the vibration face portion 13 and is vibrated with vibration of the vibration face portion 13.

The vibration face portion 13 radiates sound wave by propagating vibration energy generated from the voice coil 2 to the air. On the upper face (surface) of the vibration face portion 13, the rectangular-shaped mass adjustment member 5 for stabilizing the vibration state of the diaphragm 1 is fixed by e.g. adhesion by an adhesive or the like (see FIG. 1 also). The mass adjustment member 5 is a member for adjusting sound quality such as mass adjustment or vibration damping of the vibrating face of the diaphragm 1. The details thereof will be discussed later.

The voice coil 2 is a conductive member in the form of an angular tube having a length of conductive wire wound around it and acts as a magnetic field generating mechanism configured to generate a magnetic field corresponding to a direction and a magnitude of electric current supplied thereto. The voice coil 2, through an interaction between the magnetic field self-generated and a magnetic field generated by a magnet M to be described later, converts energy of electricity supplied thereto into a vibration energy and vibrates itself with amplitude along the vertical direction. And, the voice coil 2 vibrates the vibration face portion 13 with this vibration.

The voice coil 2 includes a rectangular-shaped winding portion 21 and a pair of leads 22, 22 (leaders). The axial direction (thickness direction) of the winding portion 21 is aligned with the vertical direction. The upper face of this winding portion 21 is fixed to the lower face of the vibration face portion 13 through adhesion using an adhesive or the like. The vibration energy generated by the vertical vibrating motion of the voice coil 2 is transmitted to the vibration face portion 13 to be converted into a sound wave. The pair of leads 22, 22 are electrically connected to a pair of terminals 7, 7.

The frame 3 is a frame body having a rectangular annular shape and formed of a resin material such as polyphthalamide resin. The frame 3 includes a first frame 3A disposed on the surface side of the diaphragm 1 and a second frame 3B disposed on the back face side of the diaphragm 1.

The first frame 3A includes a first frame portion 31 having a rectangular annular shape and a plurality of (four in this embodiment) leg portions 32 extending downwards from the lower faces of the four corners of the first frame portion 31. The first frame portion 31 further includes an outer frame portion 31a where an annular portion 52b of the mass adjustment member 5 is disposed and an inner frame portion 31b receded upwards from the outer frame portion 31a. With this arrangement, between the inner frame portion 31b and the mass adjustment member 5, a space is formed. Each leg portion 32 is formed to have an L-shaped cross section so as to stride over two intersecting sides of the outer frame portion 31a constituting the corner portion of the first frame portion 31. The portion corresponding to the corner portion of the first frame portion 31 includes a cutaway portion 32a formed by cutting away the corner portion into a rectangular shape to form a through hole.

The second frame 3B includes a rectangular annular-shaped second frame portion 33, terminal supporting portions 34 extending inwards from the opposed sides forming the short sides of the second frame portion 33 and supporting a pair of terminals 7, 7, a plurality of (four in this embodiment) bottom plate fixing portions 35 which extend inwards along the long sides from the four corners of the second frame portion 33 and to which the four corners of the bottom plate 6 are fixedly bonded. The terminal 7 in this embodiment has one end thereof on the side of the frame 3 electrically connected to the lead 22. The other end of the terminal 7 includes an external terminal 71 exposed to the outside, a folded portion 72 folded in U-shape from the other end of the external terminal 71 and an extending portion 73 extending inwards from the folded portion 72 and having its leading end bent.

On the upper face of the second frame portion 33, the back face of the outer circumferential frame portion 11 of the diaphragm 1 described above is bonded. This second frame portion 33 incudes a plurality of (four in this embodiment) protrusions 33a protruding at the four corners and a plurality of (four in this embodiment) cutouts 33b provided at the positions corresponding to the protrusions 33a as cutouts along the inner contours of the leg portions 32 of the first frame 3A. As the protrusions 33a are engaged in the cutaway portions 32a of the leg portions 32 with the cutouts 33b being placed along the inner contours of the leg portions 32, the first frame 3A and the second frame 3B are fixed to each other (see also FIG. 1).

The terminal supporting portions 34 include terminal platforms 34a on whose upper faces the external terminals 71 are placed, supporting recesses 34b which are formed by receding the lower faces of the cutouts 33b provided at the corners of the opposed ends of one long side of the second frame portion 33 and along which the folded portions 72 of the terminals 7 extend from the upper face to the lower face, and supporting wall portions 34c supporting the extending portions 73 of the terminals 7 via lower faces thereof. At a portion of this supporting wall portion 34c where the bent leading end of the extending portion 73 is disposed, a through hole 34c1 is formed as a space allowing elastic deformation of this leading end.

The magnetic circuit 4 includes a magnet M and a pole piece B. The magnet M is a permanent magnet such as a ferrite magnet. The magnet M causes its magnetic field to act on the voice coil 2. In this embodiment, the magnet M includes a first magnet 41 in the form of a rectangular plate disposed in the inner area of the winding portion 21 in the direction perpendicular to the axis direction of the winding portion 21 of the voice coil 2 and a pair of second magnets 42, 42 in the form of rectangular plates disposed in the outer areas of the winding portion 21 (see also FIG. 4). The first magnet 41 and the second magnets 42, 42 are disposed at the area downwardly of the winding portion 21 of the voice coil 2 in the vertical direction. Further, the first magnet 41 and the second magnets 42, 42 are placed on the upper face of the bottom plate 6. In this embodiment, the first magnet 41 and the second magnets 42, 42 are fixed to the upper face of the bottom plate 6 with adhesive or the like.

The first magnet 41 and the second magnets 42, 42 are disposed under a posture of the respective plate faces thereof intersecting the vertical direction (e.g. orthogonal thereto). Magnetic fields generated from the first magnet 41 and the second magnets 42, 42 are set to be opposite directions to each other. For instance, in case the magnetic pole of the upper face of the first magnet 41 is N pole, the magnetic poles of the upper faces of the second magnets 42, 42 are S poles. In this case, the magnetic field generated from the first magnet 41 passes along the outer circumference of the winding portion 21 from the upper face thereof to extend to the upper faces of the second magnets 42, 42. The second magnets 42, 42 in this embodiment are disposed with their longitudinal axis direction thereof aligned with the long sides of the second frame portion 33.

The pole piece B includes a first pole piece 43 in the form of a rectangular plate disposed in the inner area of the winding portion 21 and a pair of second pole pieces 44, 44 in the form of rectangular plates disposed at the outer areas of the winding portion 21. The first pole piece 43 is fixed to the upper face of the first magnet 41 via e.g. adhesion using an adhesive and the pair of second pole pieces 44,44 are fixed respectively to the upper faces of the second magnets 42, 42 via e.g. adhesion using an adhesive. The cross sectional shape of the horizontal face of the first pole piece 43 orthogonal to the vertical direction has a same rectangular shape as the cross sectional shape of the horizontal face of the first magnet 41. The first pole piece 43 is disposed inwardly away from the inner circumferential face of the winding portion 21 of the voice coil 2 (see also FIG. 4). A portion of the first magnet 41 and the first pole piece 43 are arranged to be overlapped with the winding portion 21 as seen in the direction perpendicular to the axial direction of the winding portion 21. Namely, the upper face of the first pole piece 43 is arranged to be located between the upper face and the lower face of the winding portion 21 in the vertical direction. The first pole piece 43 is formed of a magnetizable material (magnetic material) and configured to converge magnetic fluxes generated by the first magnet 41 to be interlinked with the winding portion 21.

Each one of the pair of second pole pieces 44, 44 has its longitudinal direction aligned with the longitudinal direction of the second magnets 42, 42. The second pole pieces 44, 44 are disposed outwardly away from the outer circumferential face of the winding portion 21. The second pole pieces 44, 44 are disposed to be overlapped with the second magnets 42, 42 as seen in the vertical direction and located in the inner areas of the second magnets 42, 42 (the areas adjacent the voice coil 2). A part of each second magnet 42, 42 and each second pole piece 44, 44 are disposed to be overlapped with the winding portion 21 as seen in the direction perpendicular to the axis direction of the winding portion 21. Namely, the upper face of each second pole piece 44, 44 is disposed to be located between the upper face and the lower face of the winding portion 21 in the vertical direction. The second pole pieces 44, 44 are formed of a magnetizable material (magnetic material) and configured to converge magnetic fluxes generated by the second magnets 42, 42 to be interlinked with the winding portion 21. In this embodiment, the upper faces of the second pole pieces 44, 44 are lower than the upper face of the first pole piece 43 and form a gap relative to the convexly shaped lowermost end of the edge portion 12 of the diaphragm 1 (see FIG. 4). With this arrangement, when the edge portion 12 of the diaphragm 1 vibrates in the vertical direction, the second pole pieces 44, 44 are prevented from coming into contact with the edge portion 12.

In this way, the magnetic fluxes generated from the upper faces of the first magnet 41 and the second magnets 42, 42 are converged by the first pole piece 43 and the second pole pieces 44, 44 respectively to be interlinked with the winding portion 21. With this, even when an electric current flowing in the voice coil 2 is small, it is possible to cause a large electromagnetic force to be applied to the voice coil 2 thereby to generate a large vibration. Consequently, the speaker X can produce a large sound with a small amount of electric current.

The mass adjustment member 5 is a member in the form of a thin plate for sound adjustment such as mass adjustment or vibration control of the vibration face portion 13 acting as the vibration face of the diaphragm 1. The mass adjustment member 5 is constituted of a resin material such as PEN (polyethylene naphthalate, etc.) having greater rigidness than the diaphragm 1, but may be constituted of a metal thin plate or the like also.

The mass adjustment member 5 comprises a one-piece structure including a plate face portion 51 to be fixed to the surface of the vibration face portion 13 and a damper 52 extending outwards from the plate face portion 51. In the case of the mass adjustment member 5 of this embodiment, the plate face portion 51 and the damper 52 are formed to be located in a same plane.

The plate face portion 51 is constituted of a plate member having a same rectangular shape and a same surface area as the vibration face portion 13. The lower face of this plate face portion 51 is fixed to the surface of the vibration face portion 13 through adhesion using an adhesive for instance, so as to stabilize the vibrating state of the diaphragm 1. Incidentally, the plate face portion 51 may have a larger surface area than the vibration face portion 13. In this case, due to the resultant increase of the effective areas of vibration of the vibration face portion 13 and the plate face portion 51, it becomes possible to increase the sound pressure, so that the acoustic range of the speaker X can be extended.

The damper 52 includes a plurality of (four in total, two for each one of the pair of sides) elongate plate portions 52a extending in the form of an elongate plate having one end connected to a pair of sides (long sides) of the plate face portion 51 and extending parallel with the plate face of the diaphragm 1 from the side and an annular portion 52b connecting the other ends of the plurality of elongate plate portions 52a in a rectangular annular form. The damper 52 is a vibration damping mechanism for absorbing (damping) abnormal vibration transmitted from the voice coil 2 to the vibration face portion 13 and the plate face portion 51.

Each elongate plate portion 52a has one end thereof extending from the vicinity of the center of the pair of long sides of the plate face portion 51 and the other end thereof connected to a short side end adjacent a corner portion 52b1 of the annular portion 52b. This elongate plate portion 52a includes an inclined portion 52a1 inclined relative to a pair of straight portions 52b2 constituting the long sides of four straight portions 52b2 of the annular portion 52b and a curved portion 52a2 curved inwards in an arcuate form from the inclined portion 52a1, of the four straight portions 52b2 of the annular portion 52b. The annular portion 52b is formed of four corner portions 52b1 having arcuate shape and four straight portions 52b2 formed between the four corner portions 52b1 respectively and has a same rectangular shape and a same surface area as the outer circumferential frame portion 11 of the diaphragm 1. The lower face of the annular portion 52b is fixed to the surface of the outer circumferential frame portion 11 of the diaphragm 1 through adhesion using an adhesive for instance. Namely, the annular portion 52b, as being overlapped with the outer circumferential frame portion 11 of the diaphragm 1 as seen in the vertical direction, is sandwiched between the first frame 3A and the outer circumferential frame portion 11 (second frame 3B).

The bottom plate 6 is formed of a metallic magnetizable material (magnetic material) such as a cold rolled steel sheet. The bottom plate 6 includes a flat plate portion 61 and bent portions 62 formed by upwardly bending respective short sides of the flat plate portion 61. In the upper face of the flat plate portion 61, there are provided many bottomed holes formed at positions where the first magnet 41 and the pair of second magnets 42, 42 are to be bonded. These holes provide an anchoring effect, thus enhancing the bonding strength. At the four corners of the flat plate portion 61, there are formed a plurality of (four in this embodiment) protrusions 61a protruding from the corners of the long side along the short side, and between one pair of protrusions 61a along the long side, a plurality of (two in this embodiment) recesses 61b are formed. The circumferences of these protrusions 61a are fixedly bonded to the lower face of the bottom face fixing portion 35 of the second frame 3B, thus allowing visual inspection of a part of the lower face of the second magnet 42 via the recess 61b (see also FIG. 4). Further, the bent portion 62 is disposed between the supporting wall portion 34c of the terminal supporting portion 34 and the first magnet 41 and the first pole piece 43 (the winding portion 21 of the voice coil 2).

As described above, since the voice coil 2 is fixed to the back face of the diaphragm 1, there is no need to provide a bobbin suspending the diaphragm 1, so the assembly readiness can be improved. Since the mass adjustment member 5 opposed to the surface of the diaphragm 1 includes the damper 52, abnormal vibration of the diaphragm 1 can be suppressed without increasing the number of components. Furthermore, since the damper 52 is included in the mass adjustment member 5 opposed to the surface of the diaphragm 1, an accommodating space for such parts as the voice coil 2 and the magnetic circuit 4 which are to be provided on the back face side of the diaphragm 1 is secured, so that the degree of designing freedom is increased and also compactization is made possible. Further, thanks to the damper 52 extending outwards from the plate face portion 51 fixed to the vibration face portion 13, vibration damping performance for abnormal vibration propagated from the vibration face portion 13 via the plate face portion 51 can be increased. Moreover, since the mass adjustment member 5 is provided with higher rigidness than the diaphragm 1, it becomes easier to generate a bass (low-frequency) sound through reduction of the lowest resonance frequency, whereby the acoustic range of the speaker X can be extended advantageously.

Also, if the edge portion 12 is formed convex on the back face side of the diaphragm 1, the tensile stress for the diaphragm 1 to the back side is increased, so that distortion of the diaphragm 1 can be further suppressed. Furthermore, it becomes possible to arrange the diaphragm 1 and the mass adjustment member 5 without needing to care about possible interference between the damper 52 of the mass adjustment member 5 disposed on the surface of the diaphragm 1 and the edge portion 12, so that further compactization is made possible. Also, since the elongate plate portion 52a of the damper 52 is extended from the pair of sides of the plate face portion 51, manufacture is made easy and the damping performance can be exerted effectively by the damper 52. With provision of the annular portion 52b connecting the other end of this elongate plate portion 52a, handling of the mass adjustment member 5 is made easy, and the assembly readiness can be further improved. Moreover, if the outer circumferential frame portion 11 of the diaphragm 1 and the annular portion 52b of the mass adjustment member are overlapped with each other when being sandwiched between the outer circumferential frame portion 11 (the second frame portion 3B) and the first frame 3A, the assembly readiness can be further increased, and also, the postures of the diaphragm 1 and the mass adjustment member 5 can be stabilized.

### Other Embodiments

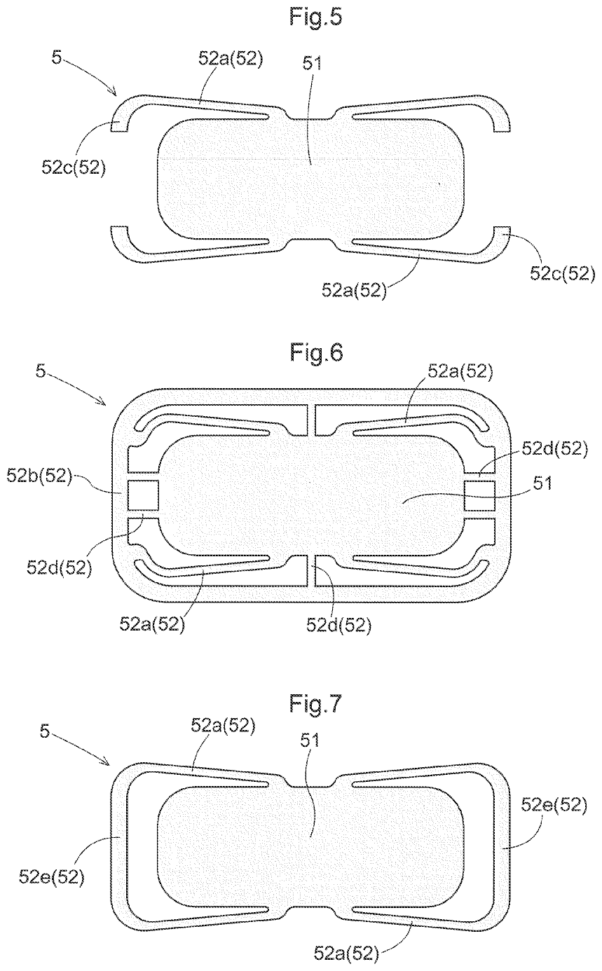

(1) As shown in FIG. 5, in the damper 52 of the mass adjustment member 5 of the above-described embodiment, the annular portion 52b may be omitted and there may be provided a bent portion 52c formed by bending the leading end portion of the elongate plate portion 52a and this bent portion 52c may be sandwiched between the outer circumferential frame portion 11 (second frame 3B) of the diaphragm 1 and the first frame 3A.

(2) As shown in FIG. 6, in the damper 52 of the mass adjustment member 5 of the above-described embodiment, in addition to the elongate plate portion 52a, there may be provided a plurality of (six in the illustration) straight line-like connecting portions 52d for connecting the plate face portion 51 to the annular portion 52b.

(3) As shown in FIG. 7, in the damper 52 of the mass adjustment member 5 of the above-described embodiment, instead of the annular portion 52b, there may be provided a coupling portion 52e to which the leading end portions of the pair of elongate plate portions 52a are coupled and this coupling portion 52a may be sandwiched between the outer circumferential frame portion 11 (second frame 3B) of the diaphragm 1 and the first frame 3A.

(4) The elongate plate portion 52a of the damper 52 of the above-described embodiment may be provided in a steplike form or wavelike form.

(5) As long as the speaker X has the damper 52 formed integrally with the mass adjustment member 5 of the above-described embodiment, the shapes of the voice coil 2, the frame 3 and the magnetic circuit 4, etc. are not particularly limited.

1. A speaker comprising:
a diaphragm having a vibration face portion vibrated to radiate a sound wave;
a voice coil fixed to a back face of the vibration face portion;
a frame supporting the diaphragm;
a magnetic circuit vibrating the diaphragm; and
a mass adjustment member opposed to a surface of the diaphragm and configured to adjust the mass of the vibration face portion, the mass adjustment member including a plate face portion fixed to the surface of the vibration face portion and a damper extending outwards from the plate face portion.

2. The speaker of claim 1, wherein the mass adjustment member has a greater rigidness than the diaphragm.

3. The speaker of claim 1, wherein the diaphragm includes an edge portion that extends in a circumference of the vibration face portion, the edge portion being formed convex on the back face side.

4. The speaker of claim 2, wherein the diaphragm includes an edge portion that extends in a circumference of the vibration face portion, the edge portion being formed convex on the back face side.

5. The speaker of claim 1, wherein:
the plate face portion has a rectangular shape; and
the damper includes a plurality of elongate plate portions each having one end connected to a pair of sides of the plate face portion and extending in a form of elongate plate from the sides and an annular portion connecting the other ends of the elongate plate portions.

6. The speaker of claim 2, wherein:
the plate face portion has a rectangular shape; and
the damper includes a plurality of elongate plate portions each having one end connected to a pair of sides of the plate face portion and extending in a form of elongate plate from the sides and an annular portion connecting the other ends of the elongate plate portions.

7. The speaker of claim 3, wherein:
the plate face portion has a rectangular shape; and
the damper includes a plurality of elongate plate portions each having one end connected to a pair of sides of the plate face portion and extending in a form of elongate plate from the sides and an annular portion connecting the other ends of the elongate plate portions.

8. The speaker of claim 4, wherein:
the plate face portion has a rectangular shape; and
the damper includes a plurality of elongate plate portions each having one end connected to a pair of sides of the plate face portion and extending in a form of elongate plate from the sides and an annular portion connecting the other ends of the elongate plate portions.

9. The speaker of claim 5, wherein:
the diaphragm includes an annular circumferential edge portion which is to be bound by the frame; and
the annular portion is sandwiched between the circumferential edge portion and the frame, with the annular portion being overlapped with the circumferential edge portion.

10. The speaker of claim 6, wherein:
the diaphragm includes an annular circumferential edge portion which is to be bound by the frame; and
the annular portion is sandwiched between the circumferential edge portion and the frame, with the annular portion being overlapped with the circumferential edge portion.

11. The speaker of claim 7, wherein:
the diaphragm includes an annular circumferential edge portion which is to be bound by the frame; and
the annular portion is sandwiched between the circumferential edge portion and the frame, with the annular portion being overlapped with the circumferential edge portion.

12. The speaker of claim 8, wherein:
the diaphragm includes an annular circumferential edge portion which is to be bound by the frame; and
the annular portion is sandwiched between the circumferential edge portion and the frame, with the annular portion being overlapped with the circumferential edge portion.

13. The speaker of claim 1, wherein the plate face portion has a surface area greater than the vibration face portion.

14. The speaker of claim 2, wherein the plate face portion has a surface area greater than the vibration face portion.

15. The speaker of claim 3, wherein the plate face portion has a surface area greater than the vibration face portion.

16. The speaker of claim 5, wherein the plate face portion has a surface area greater than the vibration face portion.

17. The speaker of claim 9, wherein the plate face portion has a surface area greater than the vibration face portion.
